(19) United States
(12) Patent Application Publication
(10) Pub. No.: US 2025/0141001 A1
(43) Pub. Date: May 1, 2025

(54) POWER STORAGE DEVICE AND METHOD OF MANUFACTURING THE POWER STORAGE DEVICE

(71) Applicants: Prime Planet Energy & Solutions, Inc., Tokyo (JP); TOYOTA JIDOSHA KABUSHIKI KAISHA, Aichi-ken (JP); PRIMEARTH EV ENERGY CO., LTD., Shizuoka-ken (JP)

(72) Inventors: Satoshi FUJIMURA, Toki-shi (JP); Yuki SATO, Toyota-shi (JP); Yozo UCHIDA, Toyota-shi (JP); Nozomi TATEYAMA, Okazaki-shi (JP); Masahiro UCHIMURA, Miyoshi-shi (JP); Masataka ASAI, Toyota-shi (JP); Shigeru MATSUMOTO, Toyohashi-shi (JP); Takashi TAKIMOTO, Kosai-shi (JP); Shunsuke NAKAMURA, Hamamatsu-shi (JP); Keitaro MACHIDA, Hamamatsu-shi (JP)

(21) Appl. No.: 18/898,674

(22) Filed: Sep. 27, 2024

(30) Foreign Application Priority Data
Oct. 31, 2023 (JP) 2023-186976

(51) Int. Cl. H01M 50/188; H01M 50/184; H01M 50/193

(52) U.S. Cl. CPC H01M 50/188; H01M 50/184; H01M 50/193

(57) ABSTRACT

A power storage device includes a case member, a terminal member, and a resin member that fixes the terminal member to the case member. At least one of a case seal portion and a terminal seal portion has a plurality of first seal portions each of which extends continuously over the entire periphery in a circumferential direction and is subjected to cohesive failure when a joint with the resin member breaks down, and a second seal portion that is disposed between the first seal portions adjacent to each other, extends continuously over the entire periphery in the circumferential direction, and is subjected to interfacial failure when a joint with the resin member breaks down.

### CROSS-REFERENCE TO RELATED APPLICATIONS

This application is based upon and claims the benefit of priority to Japanese Patent Application No. 2023-186976 filed on Oct. 31, 2023, the entire contents of which are incorporated herein by reference.

### BACKGROUND

### Technical Field

The disclosure relates to a power storage device in which a terminal member is fixed via a resin member to a case member that constitutes a case, and also relates to a method of manufacturing the power storage device.

### Related Art

As a power storage device, a battery is known in which positive and negative terminal members are fixed via respective resin members to a case lid member (a case member) in the form of a rectangular plate that constitutes a case in the form of a rectangular parallelepiped box. Specifically, each of the positive and negative terminal members is inserted through an insertion hole formed in the case lid member, to extend from the inside of the case to the outside. The resin member is hermetically joined to a continuous band-shaped case seal portion of the case lid member surrounding the insertion hole and a continuous band-shaped terminal seal portion of the terminal member located near the insertion hole while insulating the case seal portion and the terminal seal portion from each other. Thus, a hermetic seal is provided between the terminal seal portion of the terminal member and the resin member in a width direction (which may also be referred to as “sealing direction”) of the terminal seal portion, and a hermetic seal is also provided between the case seal portion of the case lid member and the resin member in a width direction (which may also be referred to as “sealing direction”) of the case seal portion. One example of the related art is described in Japanese unexamined patent application publication No. 2022-079172 (JP 2022-079172 A) (see FIG. 2. FIG. 6, FIG. 7, etc.).

### SUMMARY

### Technical Problems

In the known battery, the terminal seal portion of the terminal member is firmly joined over the entire surface to the resin member, so that cohesive failure occurs on the entire surface of the terminal seal portion when a joint of the terminal seal portion and the resin member breaks down. The case seal portion of the case member is also firmly joined over the entire surface to the resin member, so that cohesive failure occurs on the entire surface of the case seal portion when a joint of the case seal portion and the resin member breaks down.

However, it has been found that, in the battery as described above, if a crack (cracking) occurs in the resin member at the junction of the terminal seal portion and the resin member or at the junction of the case seal portion and the resin member, the crack may subsequently extend in the sealing direction and cause a seal brake (seal failure).

The disclosure was made in view of the situation as described above, and provides a power storage device that can curb occurrence of seal failure even if a crack forms in the resin member at the junction of the seal portion of the case member or the terminal member and the resin member. The disclosure also provides a method of manufacturing the power storage device.

### Means of Solving the Problems

(1) One aspect of the disclosure for solving the above problem is a power storage device including a case member having an insertion hole and including a continuous band-shaped case seal portion that surrounds the insertion hole, a terminal member that is inserted through the insertion hole of the case member and includes a continuous band-shaped terminal seal portion located near the insertion hole, and a resin member hermetically joined to the case seal portion of the case member and the terminal seal portion of the terminal member while insulating the case seal portion and the terminal seal portion from each other, to fix the terminal member to the case member. In the power storage device, at least one seal portion of the case seal portion and the terminal seal portion has a plurality of first seal portions each of which extends continuously over the entire periphery in a circumferential direction of the seal portion and is subjected to cohesive failure when a joint of the first seal portion and the resin member breaks down, and a second seal portion that is disposed between the first seal portions adjacent to each other in a width direction of the seal portion. The second seal portion extends continuously over the entire periphery in the circumferential direction of the seal portion and is subjected to interfacial failure when a joint of the second seal portion and the resin member breaks down.

In the power storage device described above, at least one seal portion of the case seal portion and the terminal seal portion is not firmly joined over the entire surface to the resin member so that cohesive failure occurs on the entire surface of the seal portion (the seal portion is not entirely provided by the first seal portion), but the seal portion has two or more continuous or endless first seal portions having the possibility of cohesive failure, and one or more continuous or endless second seal portions that are located between the first seal portions and have the possibility of interfacial failure. With this arrangement, even if a crack forms in the resin member at one of the first seal portions during manufacturing or use of the power storage device, the crack can be prevented from extending to another first seal portion and breaking all of the first seal portions included in the seal portion.

More specifically, considering the progression of cracking, if cohesive failure occurs in a certain first seal portion and a crack proceeds in the sealing direction, interfacial failure easily occurs in the second seal portion adjacent to the above first seal portion because the joint of the second seal portion and the resin member is weaker than that of the first seal portion and the resin member. In the second seal portion, however, the crack does not continue to proceed in the sealing direction but also proceed in the circumferential direction, so that the stress is alleviated due to the interfacial failure in the second seal portion. Therefore, cohesive failure is prevented from occurring in the next first seal portion and the crack is prevented from further proceeding in the sealing direction. Accordingly, in the power storage device described above, even if a crack forms in the resin member at the junction of the seal portion of the case member or the terminal member and the resin member, the crack can be prevented from proceeding in the sealing direction and breaking all of the first seal portions included in the seal portion, and the occurrence of seal failure can be curbed.

Examples of the “power storage device” include secondary batteries, such as a lithium-ion secondary battery, sodium-ion secondary battery, and a calcium-ion secondary battery, and capacitors, such as a lithium-ion capacitor.

(2) In the power storage device described in (1), the seal portion may have three or more first seal portions as the first seal portions.

In the power storage device described above, the seal portion has three or more first seal portions; therefore, all of the first seal portions included in the seal portion are less likely or unlikely to be broken and the occurrence of seal failure can be further curbed, as compared with the case where the seal portion has two first seal portions.

(3) In the power storage device described in (1) or (2), nanocolumns having a height of 20 nm or greater and formed by joining particles derived from a metal that forms the case member or the terminal member together like strings of beads, into the form of columns, may stand numerously on the first seal portions, and gaps between the nanocolumns may be filled with a resin material that forms the resin member.

In the power storage device described above, the first seal portion is formed with a nano-roughened surface of a nano level (nano order) on which the nanocolumns described above stand numerously, and gaps between the numerous nanocolumns are filled with the resin material; therefore, a particularly good seal is provided between the first seal portion and the resin member.

(4) Another aspect of the disclosure is a method of manufacturing a power storage device including a case member having an insertion hole and including a continuous band-shaped case seal portion that surrounds the insertion hole, a terminal member that is inserted through the insertion hole of the case member and includes a continuous band-shaped terminal seal portion located near the insertion hole, and a resin member hermetically joined to the case seal portion of the case member and the terminal seal portion of the terminal member while insulating the case seal portion and the terminal seal portion from each other, to fix the terminal member to the case member, wherein at least one seal portion of the case seal portion and the terminal seal portion has a plurality of first seal portions each of which extends continuously over the entire periphery in a circumferential direction of the seal portion and is subjected to cohesive failure when a joint of the first seal portion and the resin member breaks down, and a second seal portion that is disposed between the first seal portions adjacent to each other in a width direction of the seal portion, the second seal portion extending continuously over the entire periphery in the circumferential direction of the seal portion and being subjected to interfacial failure when a joint of the second seal portion and the resin member breaks down. The method of manufacturing the power storage device includes forming the seal portion having the first seal portions and the second seal portion in at least one of the case member and the terminal member, and forming the resin member joined to the seal portion after the seal portion forming.

In the method of manufacturing the power storage device described above, in the process of forming the seal portion (a seal portion forming process), at least one of the case member and the terminal member can be formed with the seal portion having the two or more first seal portions and the second seal portion. In the process of forming the resin member (a resin forming process), the resin member to which the seal portion including the first seal portions and the second seal portion is joined can be formed.

In the “resin forming process”, the resin member is formed by, for example, forming (molding) the resin member joined to the case seal portion and the terminal seal portion, by insert molding using the case member and the terminal member, or forming the resin member by applying a liquid resin material to the case seal portion and the terminal seal portion and hardening the resin material.

(5) In the method of manufacturing the power storage device described in (4), nanocolumns having a height of 20 nm or greater and formed by joining particles derived from a metal that forms the case member or the terminal member together like strings of beads, into the form of columns, may stand numerously on the first seal portions, and gaps between the nanocolumns may be filled with a resin material that forms the resin member. In the seal portion forming process, the first seal portions on which the nanocolumns stand numerously may be formed by intermittently applying a pulsed laser beam to the seal portion while shifting an irradiation position, and, in the resin forming process, the resin member may be formed with the resin material filling the gaps between the nanocolumns standing numerously on the first seal portions.

In the method of manufacturing the power storage device described above, the first seal portions on which the nanocolumns stand numerously are formed using the pulsed laser beam; therefore, the first seal portions on which the nanocolumns stand numerously can be easily formed in the seal portion. In the resin forming process, the resin member is formed with the resin material filling gaps between the nanocolumns standing numerously on the first seal portions; therefore, the resin member that provides particularly good seals with the first seal portions can be formed.

### BRIEF DESCRIPTION OF THE DRAWINGS

FIG. 1 is a perspective view of a battery according to one embodiment;

FIG. 2 is a partially broken cross-sectional view of the battery according to the embodiment, taken along the battery height direction and the battery width direction;

FIG. 3 is a partially enlarged cross-sectional view of a case seal portion, a terminal seal portion, a resin member, and their vicinity of the battery according to the embodiment, which view is taken along the battery height direction and the battery thickness direction;

FIG. 4 is a partially enlarged cross-sectional view of the partially enlarged cross-sectional view of FIG. 3 according to the embodiment, showing a further enlarged view of a plurality of first seal portions and a plurality of second seal portions of the terminal seal portion and their vicinity;

FIG. 5 is a partially enlarged cross-sectional view of the partially enlarged cross-sectional view of FIG. 3 according to the embodiment, showing a further enlarged view of a plurality of first seal portions and a plurality of second seal portions of the case seal portion and their vicinity;

FIG. 6 is a partially enlarged cross-sectional view showing nanocolumns standing numerously on the first seal portion according to the embodiment;

FIG. 7 is a flowchart of a method of manufacturing the battery according to the embodiment;

FIG. 8 is an explanatory view showing the manner of forming a plurality of bowl-shaped recesses and nanocolumns standing numerously on the bowl-shaped recesses through scanning with a pulse laser beam in a seal portion forming step, in connection with the method of manufacturing the battery according to the embodiment;

FIG. 9A is an explanatory view of a resin forming step in which positive and negative terminal members are respectively inserted through insertion holes of a case lid member, in connection with the method of manufacturing the battery according to the embodiment; and

FIG. 9B is an explanatory view of the resin forming step in which a pair of resin members are respectively molded, in connection with the method of manufacturing the battery according to the embodiment.

### DETAILED DESCRIPTION OF THE EXEMPLARY EMBODIMENTS

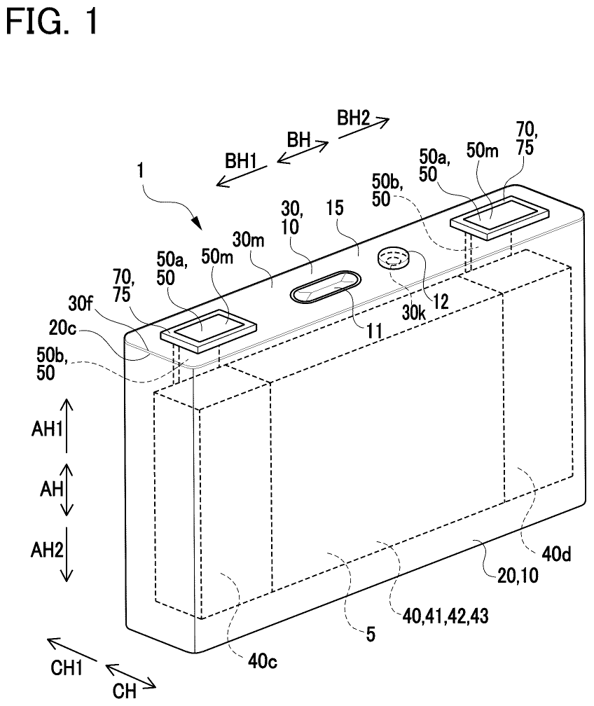

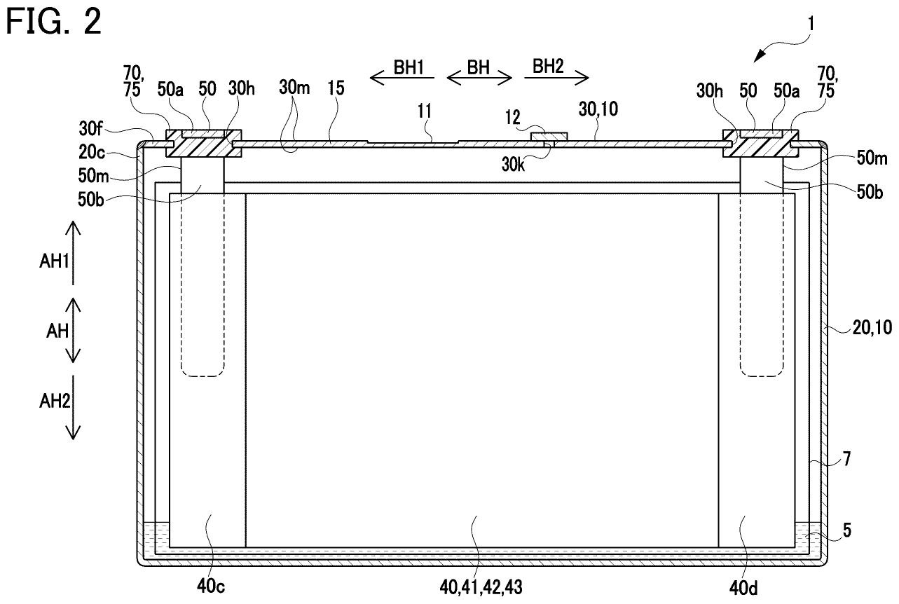

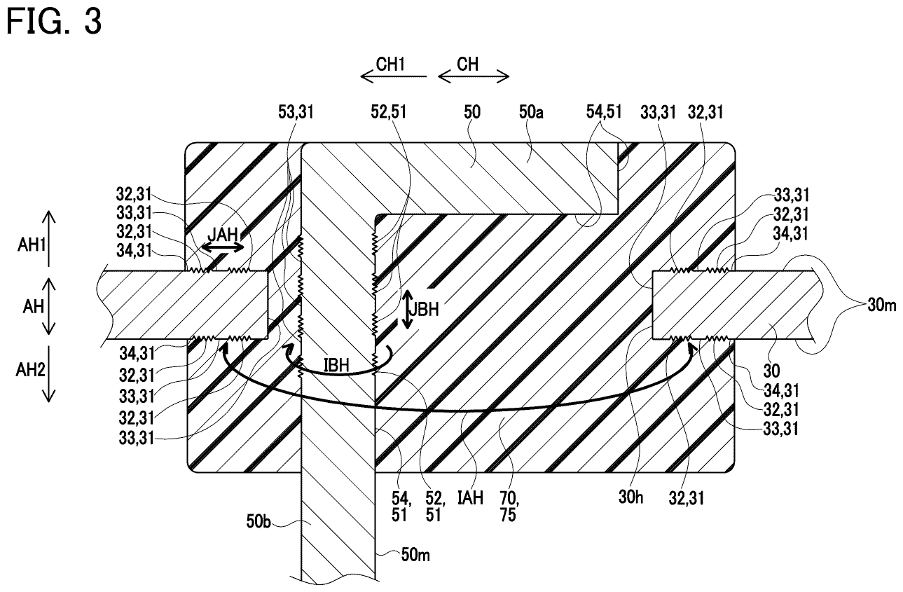

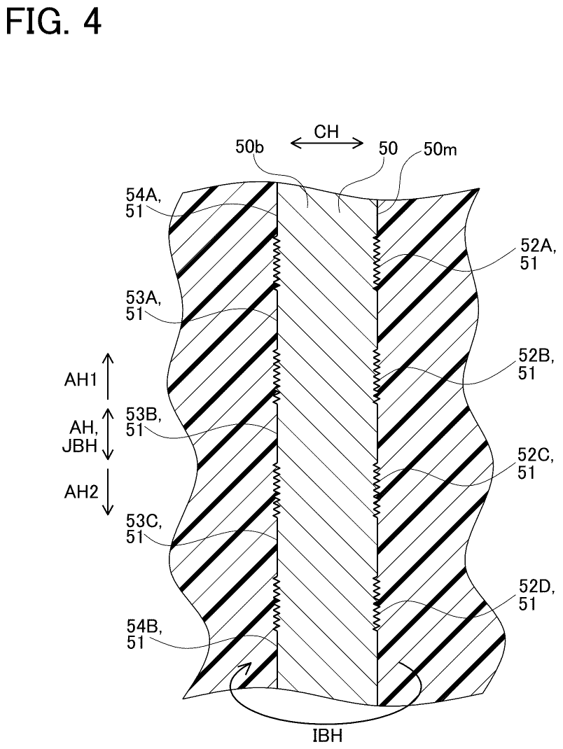

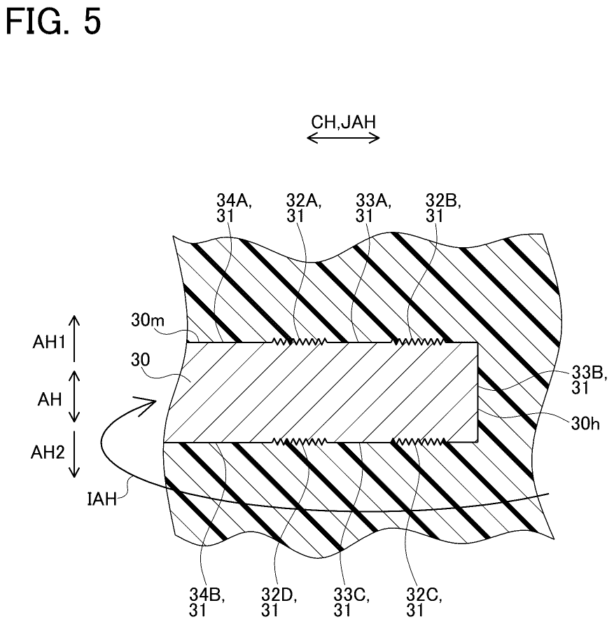

In the following, one embodiment of the disclosure will be described with reference to the drawings. FIG. 1 is a perspective view of a battery (one example of the power storage device of the disclosure) 1 according to the embodiment, and FIG. 2 is a partially broken cross-sectional view of the battery 1. FIG. 3 is a partially enlarged cross-sectional view of a terminal seal portion (one example of the seal portion of the disclosure) 51, a case seal portion (one example of the seal portion of the disclosure) 31, a resin member 70, and their vicinity of the battery 1. FIG. 4 is a partially enlarged cross-sectional view of first seal portions 52, second seal portions 53, and their vicinity of the terminal seal portion 51, and FIG. 5 is a partially enlarged cross-sectional view of first seal portions 32, second seal portions 33, and their vicinity of the case seal portion 31. In the following description, the battery height direction AH, battery width direction BH, and battery thickness direction CH of the battery 1 are defined as the directions indicated in FIG. 1 and FIG. 2.

The battery 1 is a sealed lithium-ion secondary battery having a rectangular (rectangular parallelepiped) shape, which is installed on a vehicle, such as a hybrid vehicle, plug-in hybrid vehicle, or an electric vehicle. The battery 1 is comprised of a case 10, an electrode body 40 housed in the case 10, positive and negative terminal members 50 respectively fixed to the case 10 via resin members 70, and so forth. In the case 10, the electrode body 40 is covered with a bag-like insulating holder 7 made from an insulating film. The case 10 also contains electrolyte 5, and the electrode body 40 is impregnated with a part of the electrolyte 5, while the rest of the electrolyte 5 is collected and kept on a bottom wall of the case 10.

The case 10 is shaped like a rectangular parallelepiped box and made of metal (aluminum in this embodiment). The case 10 consists of a case body 20 that is in the form of a rectangular tube with a bottom and a rectangular opening portion 20c and houses the electrode body 40 therein, and a case lid member (one example of the case member of the disclosure) 30 in the form of a rectangular plate that closes the opening portion 20c of the case body 20. The opening portion 20c of the case body 20 and a peripheral portion 30f of the case lid member 30 are hermetically welded together over the entire periphery thereof. The case lid member 30 is provided with a safety valve 11 that breaks and opens when the internal pressure of the case 10 exceeds the valve opening pressure. The case lid member 30 is also provided with a liquid inlet 30k, and the liquid inlet 30k is hermetically sealed with a disc-shaped sealing member 12 made of aluminum.

The electrode body 40 is of a rectangular parallelepiped, stacked type, and has a plurality of rectangular positive electrode sheets 41 and a plurality of rectangular negative electrode sheets 42 alternately stacked in the battery thickness direction CH via rectangular separators 43 each made from a porous resin film. In the electrode body 40, on one side BH1 in the battery width direction BH, current collecting foils of the respective positive electrode sheets 41 are superposed in the battery thickness direction CH to form a positive current collector 40c. The positive current collector 40c is conductively connected to the terminal member 50 of the positive electrode (which will be described below). Also in the electrode body 40, on the other side BH2 in the battery width direction BH, current collecting foils of the respective negative electrode sheets 42 are superposed in the battery thickness direction CH to form a negative current collector 40d. The negative current collector 40d is conductively connected to the terminal member 50 of the negative electrode (which will be described below).

Rectangular insertion holes 30h that extend through the case lid member 30 are respectively provided in portions of the case lid member 30 near its ends on one side BH1 and the other side BH2 in the battery width direction BH. The terminal member 50 of the positive electrode made of aluminum is inserted through the insertion hole 30h on the one side BH1, and the terminal member 50 is fixed to the case lid member 30 while being insulated from the case lid member 30 via the resin member 70. Also, the terminal member 50 of the negative electrode made of copper is inserted through the insertion hole 30h on the other side BH2, and the terminal member 50 is fixed to the case lid member 30 while being insulated from the case lid member 30 via the resin member 70.

Each terminal member 50 is formed by pressing a metal plate (an aluminum plate on the positive electrode, a copper plate on the negative electrode). The terminal member 50 consists of a terminal top plate 50a in the form of a rectangular plate extending in the battery width direction BH and the battery thickness direction CH and located on the upper side AH1 of the case lid member 30 in the battery height direction AH, and a terminal extension 50b that extends from the terminal top plate 50a to the lower side AH2 in the battery height direction AH. The terminal extension 50b is bent at an end portion of the terminal top plate 50a on one side CH1 in the battery thickness direction CH and extends to the lower side AH2 through the insertion hole 30h of the case lid member 30, and further through the resin member 70. The terminal extension 50b of the positive electrode is welded at its distal end portion on the lower side AH2 to the positive current collector 40c of the electrode body 40. The terminal extension 50b of the negative electrode is welded at its distal end portion on the lower side AH2 to the negative current collector 40d of the electrode body 40.

A metal surface 50m of the terminal member 50 has a terminal seal portion 51 that is a continuous band-shaped portion located in the vicinity of the insertion hole 30h, and the terminal seal portion 51 is joined to the resin member 70 (see FIG. 3 and

FIG. 4). More specifically, the terminal seal portion 51 has the inner surface that faces to the lower side AH2 and four side surfaces, as a part of the surfaces of the terminal top plate 50a, and a portion of the outer peripheral surface of the terminal extension 50b located inside the resin member 70 on the upper side AH1. The terminal seal portion 51 consists of a plurality of (four in this embodiment) first seal portions 52 (52A, 52B, 52C, 52D), a plurality of (three in this embodiment) second seal portions 53 (53A, 53B, 53C), and two third seal portions 54 (54A, 54B), and these seal portions are arranged in the direction of extension (the same direction as the battery height direction AH) of the terminal member 50.

Specifically, each of the first seal portions 52 has a rectangular continuous or endless band shape extending in the circumferential direction IBH (the circumferential direction along the battery width direction BH and the battery thickness direction CH in this embodiment) of the terminal seal portion 51 over the entire periphery. The dimension of each first seal portion 52 as measured in the width direction is equal to or larger than 360 μm (about 400 μm in this embodiment). The first seal portions 52 are firmly joined to the resin member 70 as described below, and cohesive failure occurs when the joint of the first seal portion 52 and the resin member 70 breaks down (i.e., a crack forms in the resin member 70 and the joint breaks down in the vicinity of the interface of the first seal portion 52 and the resin member 70).

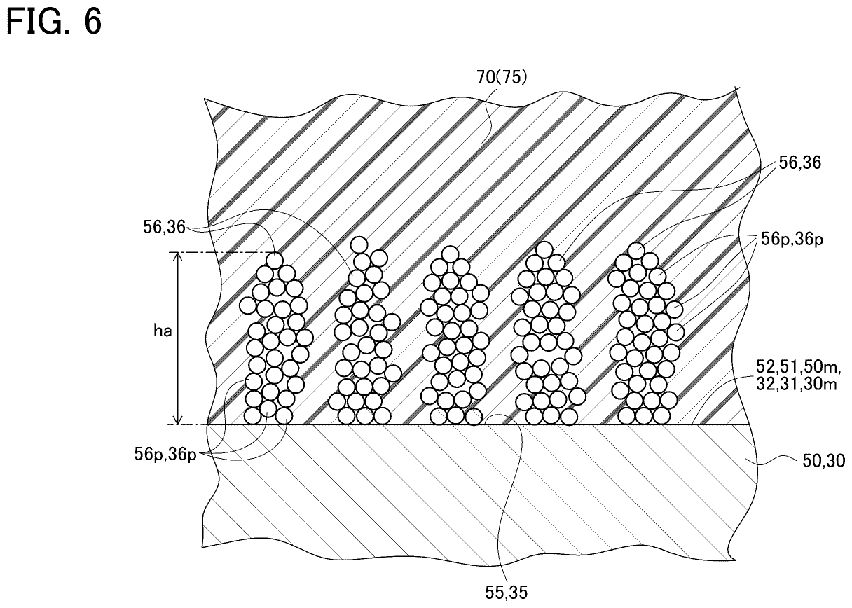

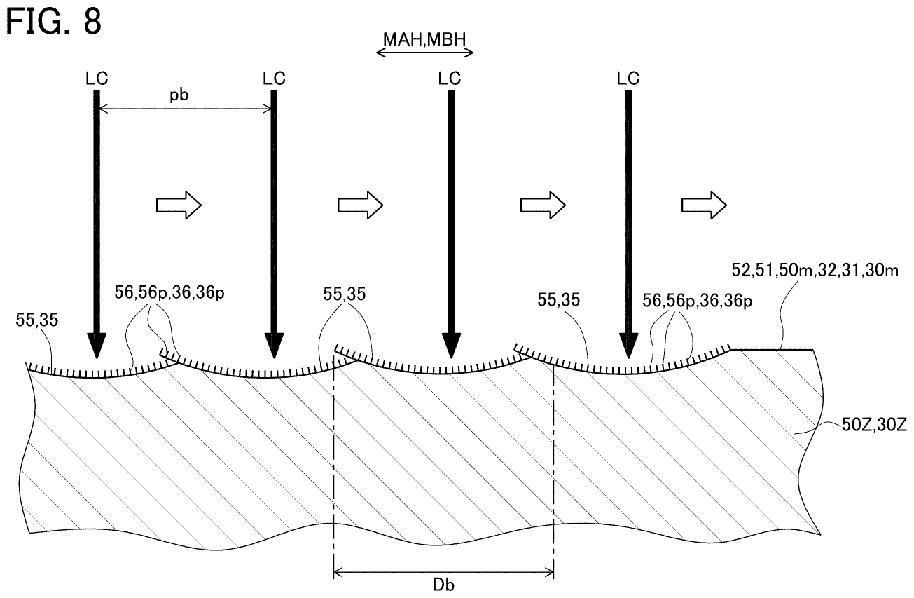

Each first seal portion 52 is roughened at the nano level with a pulsed laser beam LC that will be described below, to provide a nano-roughened surface. Specifically, in the first seal portion 52, numerous bowl-shaped recesses 55 that are dented in the shape of bowls or impact craters and have a diameter Db (see FIG. 8) of 30 um to 300 μm are arranged while partially overlapping (in this embodiment, the diameter Db is generally equal to 80 μm in the terminal member 50 of the positive electrode and the diameter Db is generally equal to 75 μm in the terminal member 50 of the negative electrode). On the bowl-shaped recesses 55, nanocolumns 56 into which particles 56p derived from metal that forms the terminal member 50 are joined together like strings of beads and which have a height ha of 20 nm or greater (the height ha is generally equal to 200 nm in this embodiment) stand together in large numbers (see FIG. 6). The metal that forms the terminal member 50 of the positive electrode is aluminum, and the nanocolumn 56 of the positive electrode consists of the particles 56p made of aluminum and aluminum oxide. On the other hand, the metal that forms the terminal member 50 of the negative electrode is copper, and the nanocolumn 56 of the negative electrode consists of the particles 56p made of copper and copper oxide.

Each of the second seal portions 53 is disposed between the first seal portions 52 adjacent to each other in the width direction (sealing direction) JBH (the same direction as the battery height direction AH in this embodiment) of the terminal seal portion 51. Each second seal portion 53 has a rectangular continuous or endless shape extending in the circumferential direction IBH of the terminal seal portion 51 over the entire periphery. The dimension of each second seal portion 53 in the width direction is equal to or larger than 360 μm (about 400 μm in this embodiment). The second seal portions 53 are weakly joined to the resin member 70 as described below, and interfacial failure occurs when the joint of the second seal portion 53 and the resin member 70 breaks down (i.e., the second seal portion 53 and the resin member 70 peel off at the interface thereof and the joint breaks down). The above-mentioned bowl-shaped recesses 55 and nanocolumns 56 are not formed in the second seal portions 53 (the second seal portion 53 is not roughened with a pulsed laser beam LC and does not have a nano-roughened surface).

Of the two third seal portions 54, one third seal portion 54A is disposed on the further upper side AH1 of the first seal portion 52A located on the uppermost side AH1. The other third seal portion 54B is disposed on the further lower side AH2 of the first seal portion 52D located on the lowest side AH2. Like the second seal portions 53, the third seal portions 54 are weakly joined to the resin member 70, and interfacial failure occurs when the joint of the third seal portion 54 and the resin member 70 breaks down. The above-mentioned bowl-shaped recesses 55 and nanocolumns 56 are not formed in the third seal portions 54.

Next, the case seal portion 31 of the case lid member 30 will be described (see FIG. 3, FIG. 5, and FIG. 6). The case seal portion 31 joined to the resin member 70 is a continuous band-shaped portion of the metal surface 30m of the case lid member 30 which surrounds each insertion hole 30h. More specifically, the case seal portion 31 has an outer hole surrounding portion of a rectangular continuous band shape surrounding the insertion hole 30h, as a part of the outer main surface of the case lid member 30 facing to the upper side AH1, an inner hole surrounding portion of a rectangular continuous band shape surrounding the insertion hole 30h, as a part of the inner main surface of the case lid member 30 facing to the lower side AH2, and the inner circumferential surface of the insertion hole 30h connecting the outer and inner hole surrounding portions. The case seal portion 31 consists of a plurality of (four in this embodiment) first seal portions 32 (32A, 32B, 32C, 32D), a plurality of (three in this embodiment) second seal portions 33 (33A, 33B, 33C), and two third seal portions 34 (34A, 34B), and these portions are arranged in the radial directions (the directions along the battery width direction BH and the battery thickness direction CH) of the insertion hole 30h.

Specifically, each of the first seal portions 32 has a rectangular continuous or endless band shape extending in the circumferential direction IAH (the circumferential direction along the battery width direction BH and the battery thickness direction CH in this embodiment) of the case seal portion 31 over the entire periphery. The dimension of each first seal portion 32 as measured in the width direction is equal to or larger than 360 μm (about 400 μm in this embodiment). The first seal portions 32 are firmly joined to the resin member 70 as described below, and cohesive failure occurs when the joint of the first seal portion 32 and the resin member 70 breaks down.

Each first seal portion 32 is roughened at the nano level with a pulsed laser beam LC that will be described below, to provide a nano-roughened surface. Specifically, in the first seal portion 32, numerous bowl-shaped recesses 35 that are dented in the shape of bowls or impact craters and have a diameter Db (see FIG. 8) of 30 μm to 300 μm are arranged while partially overlapping (in this embodiment, the diameter Db is generally equal to 80 μm). On the bowl-shaped recesses 35, nanocolumns 36 into which particles 36p derived from metal that forms the case lid member 30 are joined together like strings of beads and which have a height ha of 20 nm or greater (the height ha is generally equal to 200 nm in this embodiment) stand together in large numbers (see FIG. 6). The metal that forms the case lid member 30 is aluminum, and the nanocolumn 36 consists of the particles 36p made of aluminum and aluminum oxide.

Each of the second seal portions 33 is disposed between the first seal portions 32 adjacent to each other in the width direction (sealing direction) JAH (the radial direction of the insertion hole 30h in this embodiment) of the case seal portion 31. Each second seal portion 33 has a rectangular continuous or endless shape extending in the circumferential direction IAH of the case seal portion 31 over the entire periphery. The dimension of each second seal portion 33 as measured in the width direction is equal to or larger than 360 μm (about 400 μm in this embodiment).

The second seal portions 33 are weakly joined to the resin member 70 as described below, and interfacial failure occurs when the joint of the second seal portion 33 and the resin member 70 breaks down. The above-mentioned bowl-shaped recesses 35 and nanocolumns 36 are not formed in the second seal portions 33.

Of the two third seal portions 34, one third seal portion 34A is disposed on the further outer side of the first seal portion 32A located at the radially outer side (to the left in FIG. 5) on the upper side AH1. The other third seal portion 34B is disposed on the further outer side of the first seal portion 32D located at the radially outer side on the lower side AH2. Like the second seal portions 33, the third seal portions 34 are weakly joined to the resin member 70, and interfacial failure occurs when the joint of the third seal portion 34 and the resin member 70 breaks down. The above-mentioned bowl-shaped recesses 35 and nanocolumns 36 are not formed in the third seal portions 34.

Next, the resin members 70 will be described. The resin members 70 are formed by insert molding using a resin material 75 including a thermoplastic main resin (specifically, polyphenylene sulfide (PPS)), a thermoplastic elastomer, and a filler (specifically, a fibrous glass filler). Each of the resin members 70 is hermetically joined to the case seal portion 31 of the case lid member 30 and the terminal seal portion 51 of the terminal member 50 of the positive electrode or the negative electrode while insulating the case seal portion 31 and the terminal seal portion 51 from each other, to fix the terminal member 50 to the case lid member 30.

The resin member 70 is hermetically joined to the continuous band-shaped terminal seal portion 51 of the terminal member 50 over the entire periphery in the circumferential direction IBH. Specifically, the resin member 70 is hermetically joined with strong joining force to each of the continuous band-shaped first seal portions 52 (52A to 52D) of the terminal seal portion 51 over the entire periphery such that the resin material 75 mentioned above fills gaps between the nanocolumns 56 standing numerously on the first seal portion 52 (52A to 52D). Also, the resin member 70 is hermetically joined with weak joining force to each of the continuous band-shaped second seal portions 53 (53A to 53C) and the continuous band-shaped third seal portions 54 (54A, 54B) of the terminal seal portion 51 over the entire periphery. With this arrangement, a hermetic seal is provided between the terminal seal portion 51 of the terminal member 50 and the resin member 70 in the width direction JBH of the terminal seal portion 51.

The resin member 70 is also hermetically joined to the continuous band-shaped case seal portion 31 of the case lid member 30 over the entire periphery in the circumferential direction IAH. Specifically, the resin member 70 is hermetically joined with strong joining force to each of the continuous band-shaped first seal portions 32 (32A to 32D) of the case seal portion 31 over the entire periphery such that the resin material 75 mentioned above fills gaps between the nanocolumns 36 standing numerously on the first seal portions 32 (32A to 32D). Also, the resin member 70 is hermetically joined with weak joining force to each of the continuous band-shaped second seal portions 33 (33A to 33C) and the continuous band-shaped third seal portions 34 (34A, 34B) of the case seal portion 31 over the entire periphery. With this arrangement, a hermetic seal is provided between the case seal portion 31 of the case lid member 30 and the resin member 70 in the width direction JAH of the case seal portion 31.

In the battery 1 of this embodiment, each of the case seal portion 31 and the terminal seal portion 51 is not joined firmly to the resin member 70 so that cohesive failure occurs over the entire area of the seal portion 31, 51 (the seal portion 31, 51 is not entirely provided by the first seal portion 32, 52), but the seal portion 31, 51 is configured to have two or more continuous first seal portions 32, 52 having the possibility of cohesive failure, and two or more continuous second seal portions 33, 53 disposed between the first seal portions 32, 52 and having the possibility of interfacial failure. With this arrangement, even if a crack forms in the resin member 70 at one of the first seal portions 32, 52 during manufacturing or use of the battery 1, the crack can be prevented from extending to another first seal portion 32, 52 and breaking all of the first seal portions 32, 52 included in the seal portion 31, 51.

More specifically, considering the progression of cracking, if cohesive failure occurs in a certain first seal portion 32, 52 and a crack proceeds in the sealing direction JAH, JBH, interfacial failure easily occurs at a second seal portion 33, 53 adjacent to the first seal portion 32, 52 because the second seal portion 33, 53 is weakly joined to the resin member 70. In the second seal portion 33, 53, however, the crack does not continue to proceed in the sealing direction JAH, JBH but also proceeds in the circumferential direction IAH, IBH, so that the stress is alleviated due to the interfacial failure at the second seal portion 33, 53. Therefore, cohesive failure is prevented from occurring in the next first seal portion 32, 52 and the crack is prevented from further proceeding in the sealing direction JAH, JBH. Accordingly, in the battery 1, even if a crack forms in the resin member 70 at a junction of the seal portions 31, 51 of the case lid member 30 and the terminal member 50 and the resin member 70, the crack can be prevented from proceeding in the sealing direction JAH, JBH and breaking all of the first seal portions 32, 52 included in the seal portion 31, 51, and sealing failure can be curbed.

Further in this embodiment, each of the seal portions 31, 51 of the case lid member 30 and the terminal member 50 has three or more first seal portions 32, 52; therefore, all of the first seal portions 32, 52 included in the seal portion 31, 51 are less likely or unlikely to be broken and sealing failure is less likely or unlikely to occur, as compared with the case where the first seal portion 32, 52 has two first seal portions. In addition, the first seal portions 32, 52 of the case lid member 30 and the terminal member 50 have nano-roughened surfaces on which the nanocolumns 36, 56 stand together in large numbers, and gaps between the numerous nanocolumns 36, 56 are filled with the resin material 75. Thus, a particularly good seal can be provided between the first seal portion 32, 52 and the resin member 70.

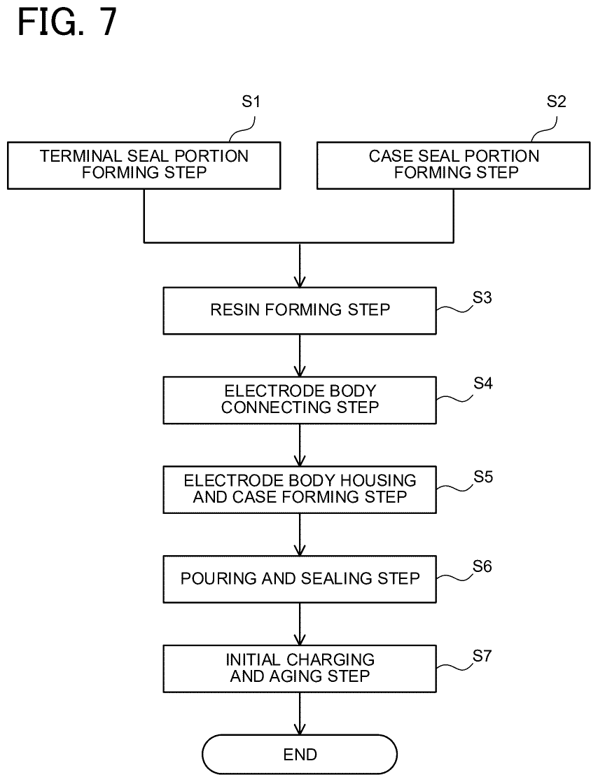

Next, a method of manufacturing the battery 1 will be described (see FIG. 7 through FIG. 9). First, a case lid member 30Z before roughening is prepared. The case lid member 30Z before roughening is obtained by press working using an aluminum plate. Terminal members 50Z before roughening are also prepared. The terminal member 50Z before roughening is obtained by press working using a metal plate (an aluminum plate for the positive electrode, a copper plate for the negative electrode).

In the “terminal seal portion forming step (seal portion forming step) S1” (see FIG. 7), a pulsed laser beam LC is intermittently applied to the terminal seal portion 51 of the metal surface 50m of the above-mentioned terminal member 50Z while shifting the irradiation position, to form four continuous band-shaped first seal portions 52 (52A to 52D) in which numerous bowl-shaped recesses 55 are arranged while partially overlapping (see FIG. 8). On the other hand, portions of the terminal seal portion 51 which are not roughened with the pulsed laser beam LC are three continuous band-shaped second seal portions 53 (53A to 53C) and two continuous band-shaped third seal portions 54 (54A, 54B).

In this embodiment, the irradiation conditions of the laser beam for the positive electrode are set as follows: the wavelength is 1064 nm, the peak power is 5 kW, the pulse width is 150 ns, the pitch pb is 75 μm, and the spot diameter Db is 80 μm. The irradiation conditions of the laser beam for the negative electrode are set as follows: the wavelength is 1064 nm, the peak power is 20 kW, the pulse width is 50 ns, the pitch pb is 60 μm, and the spot diameter Db is 75 μm.

In a circular region of the terminal seal portion 51 as seen in plan view, which region is irradiated with the pulsed laser beam LC, metal (aluminum on the positive electrode, copper on the negative electrode) near the surface is melted and further turns into vapor. As the temperature of the vapor then decreases, the vapor turns into the particles 56p (the particles 56p of aluminum and aluminum oxide on the positive electrode, the particles 56p of copper and copper oxide on the negative electrode), which are deposited on the bowl-shaped recess 55. By intermittently applying the pulsed laser beam LC to the terminal seal portion 51 while shifting the irradiation position, the particles 56p are deposited and joined together like strings of beads, into the form of columns, to form the nanocolumns 56 standing together in large numbers (see FIG. 8 and FIG. 6).

Meanwhile, in the “case seal portion forming step (seal portion forming step) S2” (see FIG. 7), a pulsed laser beam LC is intermittently applied to the case seal portion 31 of the metal surface 30m of the above-mentioned case lid member 30Z while shifting the irradiation position, to form four continuous band-shaped first seal portions 32 (32A to 32D) in which numerous bowl-shaped recesses 35 are arranged while partially overlapping (see FIG. 8). On each of the bowl-shaped recesses 35, the nanocolumns 36 formed by depositing and joining the particles 36p of aluminum and aluminum oxide together like strings of beads, into the form of columns, stand together in large numbers (see FIG. 6). On the other hand, portions of the case seal portion 31 which are not roughened with the pulsed laser beam LC are three continuous band-shaped second seal portions 33 (33A to 33C) and two continuous band-shaped third seal portions 34 (34A, 34B). The laser irradiation conditions are substantially identical with those under which the laser beam is applied to the terminal member 50 of the positive electrode in the terminal seal portion forming step S1.

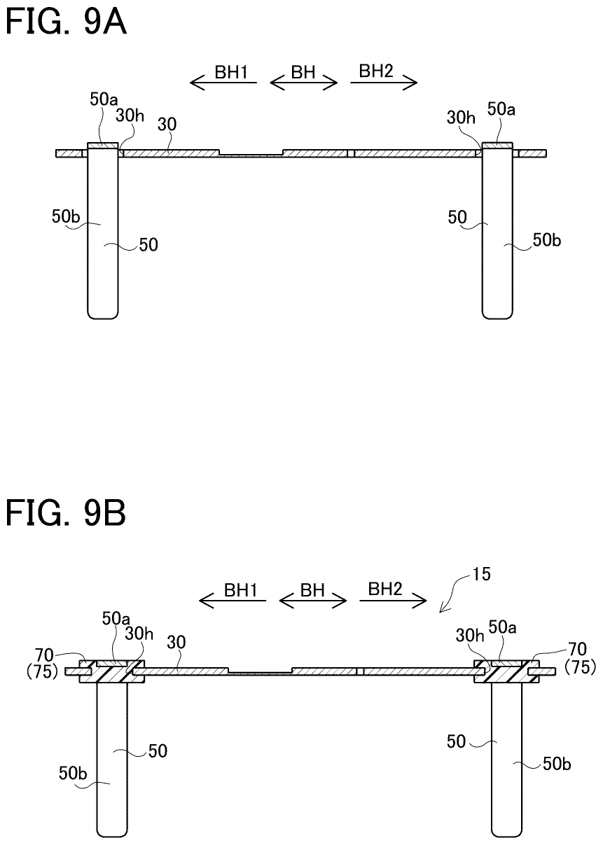

Next, in the “resin forming step S3” (see FIG. 7), the resin members 70 joined to the seal portions 31, 51 of the case lid member 30 and the terminal members 50 are formed. In this embodiment, a pair of resin members 70 are formed by insert molding (see FIG. 9), using the resin material 75 described above, in a condition where the positive and negative terminal members 50 are respectively inserted through the insertion holes 30h of the case lid member 30 (see FIG. 9).

Specifically, the resin forming step S3 is carried out using a molding die (not shown) having an upper die and a lower die. First, the case lid member 30 is placed at a predetermined position of the lower die, and the positive and negative terminal members 50 are respectively inserted through a pair of insertion holes 30h of the case lid member 30 (see FIG. 9A). Then, the upper die is moved toward the lower die to close the molding die. The molten resin material 75 is then injected into two cavities of the molding die. At this time, the resin material 75 fills gaps between the nanocolumns 36 standing numerously on the first seal portions 32 of the case lid member 30 and gaps between the nanocolumns 56 standing numerously on the first seal portions 52 of the terminal members 50.

Thus, the resin members 70 are respectively formed which are hermetically joined to the case seal portions 31 of the case lid member 30, that is, the first seal portions 32 (32A to 32D), the second seal portions 33 (33A to 33C), and the third seal portions 34 (34A, 34B), over the entire periphery in the circumferential direction IAH and also hermetically joined to the terminal seal portions 51 of the terminal members 50, that is, the first seal portions 52 (52A to 52D), the second seal portions 53 (53A to 53C), and the third seal portions 54 (54A, 54B), over the entire periphery in the circumferential direction IBH (see FIG. 9B). Then, a lid assembly 15 with the positive and negative terminal members 50 fixed to the case lid member 30 via the resin members 70 is removed from the molding die.

The first seal portions 32, 52 of the seal portions 31, 51 have the nano-roughened surfaces, and the gaps between the numerous nanocolumns 36, 56 are filled with the resin material 75, so that the first seal portions 32, 52 are firmly joined to the resin member 70. As a result, cohesive failure occurs when a joint of the first seal portion 32, 52 and the resin member 70 breaks down. On the other hand, the second seal portions 33, 53 and the third seal portions 34, 54 of the seal portions 31, 51 do not have nano-roughened surfaces and are weakly joined to the resin member 70; therefore, interfacial failure occurs when a joint of the second or third seal portion 33, 53, 34, 54 and the resin member 70 breaks down.

Next, in the “electrode body connecting step S4” (see FIG. 7), the electrode body 40 obtained by stacking the positive electrode sheets 41, negative electrode sheets 42, and separators 43 is prepared, and the terminal extension 50b of the terminal member 50 of the positive electrode as a part of the lid assembly 15 described above is welded to the positive current collector 40c of the electrode body 40 (see FIG. 2 and FIG. 1). The terminal extension 50b of the terminal member 50 of the negative electrode as a part of the lid assembly 15 is also welded to the negative current collector 40d of the electrode body 40. The electrode body 40 is then wrapped with the bag-like insulating holder 7.

Next, in the “electrode body housing and case forming step S5”, the case body 20 is prepared, the electrode body 40 covered with the insulating holder 7 is inserted into the case body 20, and the opening portion 20c of the case body 20 is closed with the case lid member 30. Then, the opening portion 20c of the case body 20 and the peripheral portion 30f of the case lid member 30 are laser welded hermetically over the entire periphery to form the case 10 with the electrode body 40 housed inside.

Next, in the “pouring and sealing step S6”, the electrolyte 5 is poured into the case 10 through the liquid inlet 30k, so that the electrode body 40 is impregnated with the electrolyte 5. The liquid inlet 30k is then covered from the outside with the sealing member 12, and the sealing member 12 is laser welded hermetically to the case 10.

Next, in “initial charging and aging step S7”, a charging device (not shown) is connected to the battery 1 to perform initial charging on the battery 1. Then, the initially charged battery 1 is left to stand for a predetermined time so that the battery 1 is aged. In this manner, the battery 1 is completed.

In the method of manufacturing the battery 1 of this embodiment, in the seal portion forming steps S1, S2, the seal portions 31, 51 having a plurality of first seal portions 32, 52 and a plurality of second seal portions 33, 53 can be formed on the case lid member 30 and the terminal members 50. In the resin forming step S3, the resin members 70 joined to the seal portions 31, 51 including the first seal portions 32, 52 and the second seal portions 33 53 can be formed.

Further in this embodiment, the first seal portions 32, 52 on which the nanocolumns 36, 56 stand numerously are formed using the pulsed laser beam LC; therefore, the first seal portions 32, 52 on which the nanocolumns 36, 56 stand numerously can be easily formed on the seal portions 31, 51. In the resin forming step S3, the resin members 70 are formed with the resin material 75 filling gaps between the nanocolumns 36, 56 standing numerously on the first seal portions 32, 52; therefore, the resin members 70 that provide particular good seals with the first seal portions 32, 52 can be formed.

While the disclosure has been described in the light of the embodiment, it is to be understood that the disclosure is not limited to the embodiment, but may be applied by making changes as needed, without departing from the principle of the disclosure.

In the embodiment, the first seal portions 32, 52 of the seal portions 31, 51 are formed with the nano-roughened surfaces on which the nanocolumns 36, 56 stand numerously, and the first seal portions 32, 52 and the resin member 70 are firmly joined together, resulting in cohesive failure. However, the disclosure is not limited to this manner of roughening, but other roughening treatments, for example, physical roughening treatments, such as shot blasting, sanding, and thermal spraying, and chemical roughening treatments, such as anodic oxidation, may also be used to form the first seal portions 32, 52 with the roughened surfaces and firmly join the first seal portions 32, 52 to the resin member 70 so that cohesive failure occurs.

### REFERENCE SIGNS LIST

1 Battery (Power storage device)
10 Case
30 Case lid member (Case member)
30h Insertion hole
31 Case seal portion (Seal portion) (of case lid member)
32, 32A, 32B, 32C, 32D First seal portion (of case seal portion)
33, 33A, 33B, 33C Second seal portion (of case seal portion)
34, 34A, 34B Third seal portion (of case seal portion)
36 Nanocolumn (of case lid member)
36p Particle (derived from metal that forms case lid member)
40 Electrode body
50 Terminal member (Metal member)
51 Terminal seal portion (Seal portion) (of terminal member)
52, 52A, 52B, 52C, 52D First seal portion (of terminal seal portion)
53, 53A, 53B, 53C Second seal portion (of terminal seal portion)
54, 54A, 54B Third seal portion (of terminal seal portion)
56 Nanocolumn (of terminal member)
56p Particle (derived from metal that forms terminal member)
70 Resin member
75 Resin material
IAH Circumferential direction (of case seal portion)
IBH Circumferential direction (of terminal seal portion)
JAH Width direction (Sealing direction) (of case seal portion)
JBH Width direction (Sealing direction) (of terminal seal portion)
ha Height (of nanocolumn)
LC Pulsed laser beam
S1 Terminal seal portion forming step (Seal portion forming step)
S2 Case seal portion forming step (Seal portion forming step)
S3 Resin forming step

What is claimed is:

1. A power storage device comprising:
a case member having an insertion hole and including a continuous band-shaped case seal portion that surrounds the insertion hole;
a terminal member that is inserted through the insertion hole of the case member and includes a continuous band-shaped terminal seal portion located near the insertion hole; and
a resin member hermetically joined to the case seal portion of the case member and the terminal seal portion of the terminal member while insulating the case seal portion and the terminal seal portion from each other, to fix the terminal member to the case member,
wherein at least one seal portion of the case seal portion and the terminal seal portion has a plurality of first seal portions each of which extends continuously over the entire periphery in a circumferential direction of the seal portion and is subjected to cohesive failure when a joint of the first seal portion and the resin member breaks down, and a second seal portion that is disposed between the first seal portions adjacent to each other in a width direction of the seal portion, the second seal portion extending continuously over the entire periphery in the circumferential direction of the seal portion and being subjected to interfacial failure when a joint of the second seal portion and the resin member breaks down.

2. The power storage device according to claim 1, wherein the seal portion has three or more first seal portions as the first seal portions.

3. The power storage device according to claim 1, wherein nanocolumns having a height of 20 nm or greater and formed by joining particles derived from a metal that forms the case member or the terminal member together like strings of beads, into the form of columns, stand numerously on the first seal portions, and gaps between the nanocolumns are filled with a resin material that forms the resin member.

4. The power storage device according to claim 2, wherein nanocolumns having a height of 20 nm or greater and formed by joining particles derived from a metal that forms the case member or the terminal member together like strings of beads, into the form of columns, stand numerously on the first seal portions, and gaps between the nanocolumns are filled with a resin material that forms the resin member.

5. A method of manufacturing a power storage device including
a case member having an insertion hole and including a continuous band-shaped case seal portion that surrounds the insertion hole,
a terminal member that is inserted through the insertion hole of the case member and includes a continuous band-shaped terminal seal portion located near the insertion hole, and
a resin member hermetically joined to the case seal portion of the case member and the terminal seal portion of the terminal member while insulating the case seal portion and the terminal seal portion from each other, to fix the terminal member to the case member,
wherein at least one seal portion of the case seal portion and the terminal seal portion has a plurality of first seal portions each of which extends continuously over the entire periphery in a circumferential direction of the seal portion and is subjected to cohesive failure when a joint of the first seal portion and the resin member breaks down, and a second seal portion that is disposed between the first seal portions adjacent to each other in a width direction of the seal portion, the second seal portion extending continuously over the entire periphery in the circumferential direction of the seal portion and being subjected to interfacial failure when a joint of the second seal portion and the resin member breaks down,
the method comprising:
forming the seal portion having the first seal portions and the second seal portion in at least one of the case member and the terminal member; and
forming the resin member joined to the seal portion after the seal portion forming.

6. The method according to claim 5, wherein:
nanocolumns having a height of 20 nm or greater and formed by joining particles derived from a metal that forms the case member or the terminal member together like strings of beads, into the form of columns, stand numerously on the first seal portions, and gaps between the nanocolumns are filled with a resin material that forms the resin member;
forming the seal portion comprises forming the first seal portions on which the nanocolumns stand numerously by intermittently applying a pulsed laser beam to the seal portion while shifting an irradiation position; and
forming the resin member comprises forming the resin member by filling the resin material into the gaps between the nanocolumns standing numerously on the first seal portions.
